(19) United States
(12) Patent Application Publication
(10) Pub. No.: US 2026/0343354 A1
(43) Pub. Date: Oct. 29, 2026

(54) METHOD FOR MOBILITY ENHANCEMENT

(71) Applicant: ZTE Corporation, Shenzhen (CN)

(72) Inventors: Mengjie ZHANG, Shenzhen (CN); He Huang, Shenzhen (CN); Jing LIU, Shenzhen (CN); Fei Dong, Shenzhen (CN); Zhihong Qiu, Shenzhen (CN)

(73) Assignee: ZTE Corporation, Shenzhen (CN)

(21) Appl. No.: 19/533,700

(22) Filed: Feb. 9, 2026

Related U.S. Application Data
(63) Continuation of application No. PCT/CN2023/112371, filed on Aug. 10, 2023.

(51) Int. Cl. H04W 36/08; H04W 12/04; H04W 76/27

(52) U.S. Cl. CPC H04W 36/08; H04W 12/04; H04W 76/27

(57) ABSTRACT

This disclosure is directed generally to wireless communications and more specifically to an improved handling of mobility of wireless terminals via subsequent conditional cell add or change and/or cell switch triggered by layer-1 and/or layer-2 command. The various example implementations are provided to describe example interactions between wireless terminals, master network nodes (MNs), and secondary network nodes (SNs) in preparation of candidate cells and cell configurations thereof for conditional cell add or change, or subsequent conditional cell add or change. Further example implementations are provided for effectuating cell switch via layer-1 and/or layer-2 command.

### TECHNICAL FIELD

This disclosure is directed generally to wireless communications and more specifically to an improved handling of mobility of wireless terminals via subsequent conditional cell add or change and/or cell switch triggered by layer-1 and/or layer-2 command.

### BACKGROUND

Wireless communication technologies are moving the world toward an increased network connectivity. Wireless communications rely on efficient network resource management and allocation between user stations and wireless access network nodes (including but not limited to wireless base stations) in a highly mobile environment. A new generation network is expected to provide high speed, low latency and ultra-reliable communication capabilities and to fulfil the requirements from different industries and users. User mobile stations or user equipment (UE) are becoming more complex in order to handle increasing amount of data communications. In order to improve communications and meet higher reliability requirements, improvements on mobility management is critical.

### SUMMARY

This disclosure is directed generally to wireless communications and more specifically to an improved handling of mobility of wireless terminals via subsequent conditional cell add or change and/or cell switch triggered by layer-1 and/or layer-2 command. The various example implementations are provided to describe example interactions between wireless terminals, master network nodes (MNs), and secondary network nodes (SNs) in preparation of candidate cells and cell configurations thereof for conditional cell add or change, or subsequent conditional cell add or change. Further example implementations are provided for effectuating cell switch triggered by layer-1 and/or layer-2 command.

In some implementations, a method performed by an MN for preparing a wireless terminal for a subsequent conditional PSCell change (CPC) procedure is disclosed. The wireless terminal may be served by the MN and an SN. The method may include receiving a candidate cell preparation message from the SN, the candidate cell preparation message comprising a cell identifier for a candidate PSCell, a candidate secondary cell group (SCG) configuration of the candidate PSCell, or an execution condition associated with the candidate PSCell for the subsequent CPC procedure; generating a reconfiguration message for the subsequent CPC based on the candidate cell preparation message, the reconfiguration message comprising a candidate cell configuration of the candidate PSCell and the execution condition; and sending the reconfiguration message to the wireless terminal.

In the example implementation above, the candidate cell preparation message may further include at least one of: a reference SCG configuration; or an indication to indicate whether the candidate SCG configuration is a full/complete or delta configuration with respect to the reference SCG configuration.

In any one of the example implementations above, the candidate cell configuration may include the candidate SCG configuration.

In any one of the example implementations above, the candidate cell configuration is contained in an MN radio resource control (RRC) reconfiguration message.

In any one of the example implementations above, the method may further include sending a request message to the SN to request a preparation for the subsequent CPC procedure, wherein the candidate cell preparation message is sent by the SN in response to the request message.

In any one of the example implementations above, the request message may include at least one of: an indication that the request message is for requesting preparation for intra-SN subsequent CPC, or an indication to request a reference SCG configuration.

In any one of the example implementations above, the request message is an SN modification request message; and the candidate cell preparation message is an SN modification request acknowledge message.

In any one of the example implementations above, the candidate cell preparation message is initiated by the SN in preparation of the subsequent CPC procedure, and the candidate cell preparation message is an SN modification required message.

In another example implementation, a method performed by a wireless terminal for a subsequent CPC procedure is disclosed. The wireless terminal may be served by a source cell in a wireless network. The method may include receiving candidate cell configurations and execution conditions for one or more candidate cells, and a cell group identifier associated with each of the one or more candidate cells; triggering a cell switch from the source cell to a target candidate cell among the one or more candidate cells when the execution condition associate with the target candidate cell is met; and determining whether the cell group identifier associated with the source cell is the same as the cell group identifier associated with the target candidate cell.

In the example implementation above, the cell group identifier indicates a cell group that a corresponding candidate cell belongs to, and wherein the cell group is configured with a security key counter list.

In any one of the example implementations above, the method further comprises, in response to the cell group identifier associated with the source cell being the same as the cell group identifier associated with the target candidate cell, performing a first procedure including at least one of: adopting a security key previously generated at the wireless terminal and associated with the source cell for communication with the target candidate cell; performing Packet Data Convergence Protocol (PDCP) data recovery for acknowledge mode data radio bearer (AM DRB); or switching to the target candidate cell.

In any one of the example implementations above, the method may further include, in response to the cell group identifier associated with the source cell being different from the cell group identifier associated with the target candidate cell, performing a second procedure, wherein the second procedure comprises at least one of: determining a cell group to which the target candidate cell belongs among a set of cell groups; regenerating the security key for communication with the target candidate cell based on a value of a selected security key counter among the security key counter list associated with the cell group; performing a PDCP re-establishment; switching to the target candidate cell; or removing the selected security key counter from the security key counter list.

In any one of the example implementations above, the security key counter list may include an ordered list of security key counters and the selected security key counter is a top-most or an unused security key counter in the ordered list of security counters.

In any one of the example implementations above, the method may further include determining whether a security key counter list associated with the cell group is empty, and in response to that the security key counter list is empty, performing at least one of: considering the target candidate cell as unavailable for a subsequent CPC; considering the target candidate cell belonging to the cell group as unavailable for the subsequent CPC; removing the candidate cell configuration of the target candidate cell or candidate cells belonging to the cell group for the subsequent CPC; suspending execution condition evaluation of the target candidate cell or candidate cells belonging to the cell group for the subsequent CPC; or reporting to the wireless network at least one of: no usable security counter for the target candidate cell or the cell group is available; the candidate cell configuration of the target candidate cell or candidate cells belonging to the cell group is released; or the execution condition evaluation of the target candidate cell or candidate cells belonging to the cell group is suspended or stopped.

In the example implementations above, reporting to the wireless network is via RRC signaling or uplink MAC CE.

In yet another example implementation, a method for CHO of a wireless terminal in a wireless network is disclosed. The method may be performed by a source MN. The wireless terminal may be served by the source MN and a source SN. The method may include transmitting an HO request message to a candidate MN, the HO request message indicating a type of CHO; receiving an HO request acknowledgement message from the candidate MN, the HO request acknowledgement message being generated by the candidate MN according to the type of CHO as indicate in the HO request message.

In the example implementation above, the type of CHO comprises at least one of: a first type indicating a conditional handover involving master cell group switching only; a second type indicating a conditional handover involving master cell group and secondary cell group switching without execution conditions associated with the secondary cell group switching; or a third type indicating a conditional handover involving master cell group and secondary cell group switching with execution conditions associated with the secondary cell group switching.

In any one of the example implementations above, the type of CHO indicated in the HO request message is the third type and the HO request message may further include at least one of: an identifier for a candidate PCell; a maximum number of candidate PSCells that the candidate MN is allowed to configure for the candidate PCell; a maximum number of conditional reconfiguration for all types of CHO that the candidate MN is allowed to configure for the candidate PCell; a maximum number of conditional reconfiguration that the candidate MN is allowed to configure for all types of CHO; or an indication to indicate whether the second or third type of CHO is requested to prepare for the candidate PCell.

In any one of the example implementations above, the type of CHO indicated in the HO request message is the third type and the HO request acknowledgement message may include at least one of: an identifier for a candidate PCell; an identifier for a candidate PSCell associated with the candidate PCell; a candidate cell configuration for the candidate PCell and the associated candidate PSCell; or execution condition parameters associated with the candidate PSCell.

In any one of the example implementations above, the execution condition parameters may include at least one of: a measurement object specific offset of a reference signal of the candidate PSCell; a cell specific offset of the candidate PSCell; a hysteresis parameter; an event threshold parameter; or a time-to-trigger parameter.

In any one of the example implementations above, the candidate PSCell is proposed by a candidate SN determined by the candidate MN and provided by the candidate SN to the candidate MN upon a request to the candidate SN by the candidate MN.

In any one of the example implementations above, the HO request message may further include a set of proposed candidate SNs or PSCells that are provided by the source SN to the source MN upon a modification request sent to the source SN by the source MN.

In any one of the example implementations above, a candidate PSCell is selected by the candidate SN from the set of proposed candidate PSCells.

In some other implementations, methods including steps relevant to and performed by other network nodes in the methods above are further disclosed.

In some other implementations, a wireless communications apparatus is disclosed. The wireless communication apparatus may include a processor and a memory, wherein the processor is configured to read code from the memory and implement any one of the methods above.

In yet some other implementations, a non-transitory computer readable medium is disclosed. The non-transitory computer readable medium may include computer instructions, when executed by a processor of a wireless communication device, may cause the wireless communication device to implement any one of the methods above.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 illustrates basic scenario for SN change/addition.

FIG. 6 illustrates secondary cell group candidates for subsequent conditional PSCell addition/change.

FIG. 7 shows an example data and logic flow among various network elements for an MN initiated subsequent conditional PSCell addition/change.

FIG. 8 shows an example data and logic flow among various network elements for an SN initiated subsequent conditional PSCell addition/change.

FIG. 9 shows an example signaling procedure for Layer 1/Layer 2 Triggered Mobility (LTM).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

### Wireless Network Overview

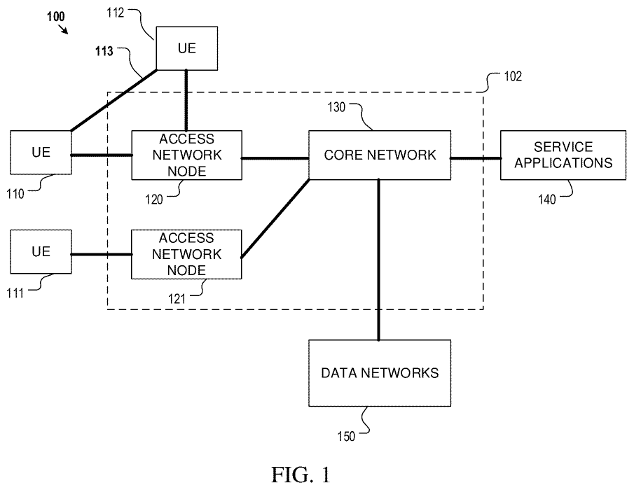

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

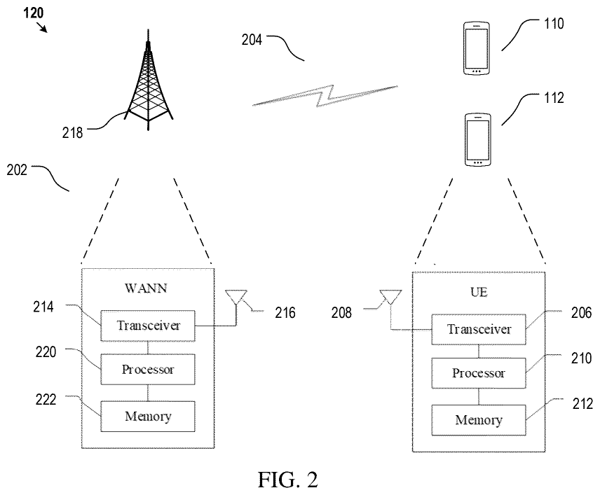

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

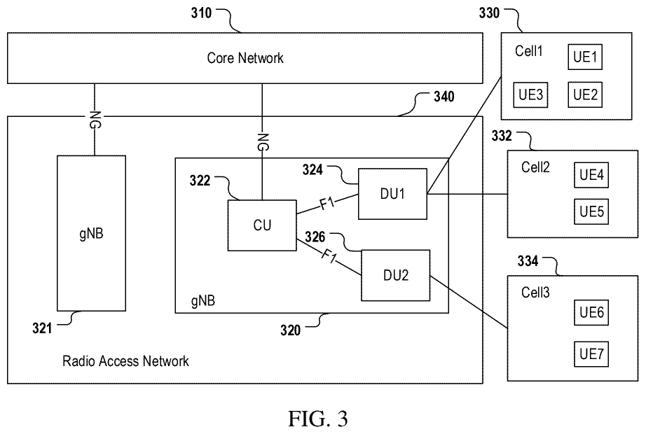

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations. The RAN 340 may be backhauled to the core network 310. The WANNs 320, for example, may further include multiple separate access network nodes in the form of a Central Unit (CU) 322 and one or more Distributed Unit (DU) 324 and 326. The CU 322 is connected with DU1 324 and DU2 326 via various interfaces, for example, an F1 interface. The F1 interface, for example, may further include an F1-C interface and an F1-U interface, which may be used to carry control plane information and user plane data, respectively. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

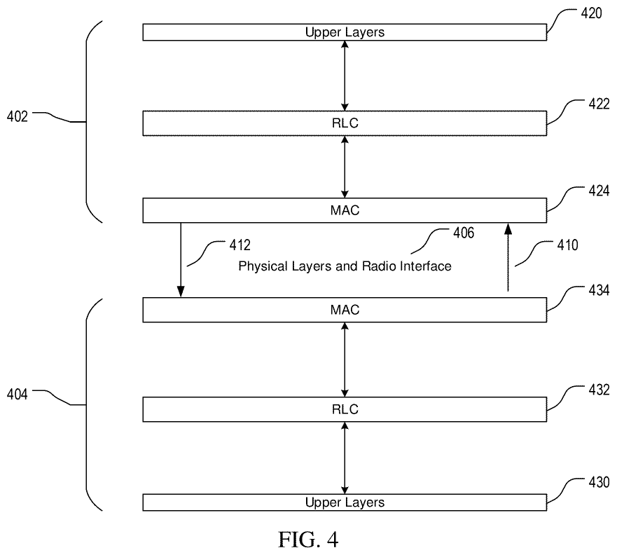

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### Conditional PSCell Addition/Change (CPAC)

UE in the wireless network may be configured to operate in Dual Connectivity, including intra-E-UTRA DC or Multi-Radio DC (MR-DC). In dual connectivity, the UE may be served by a master node (MN) and a secondary node (SN). The MN and the SN may be based the same or different radio access technologies (RAT). For example, in case of intra-E-UTRA DC, both the MN and SN provide E-UTRA access. While in case of MR-DC, one node provides NR access and the other one provides either E-UTRA or NR access.

One or multiple serving cells can be configured both on MN and SN. Serving cells configured on MN are defined as a Master Cell Group (MCG) while serving cells configured on SN are defined as a Secondary Cell Group (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

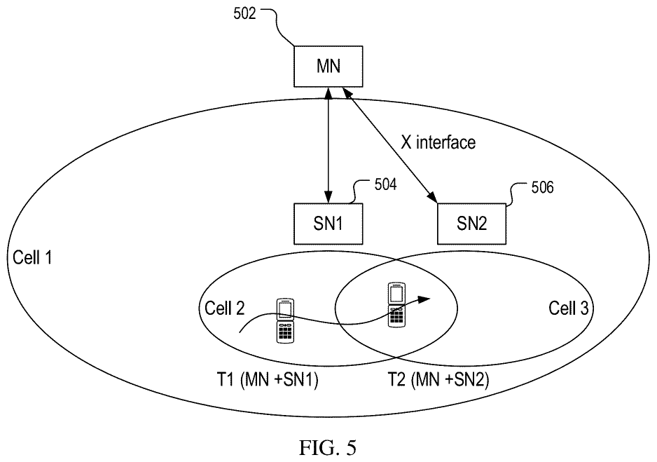

FIG. 5 illustrates one possible scenario of SN change. FIG. 5 shows three example network nodes (e.g., Base Station) including MN (502), SN1 (504) and SN2 (506). Cell 1, Cell 2 and Cell 3 are examples corresponding cells generated by MN, SN1 and SN2 respectively. Cell 2 and Cell 3 are special cell of the secondary cell group (SCG), defined as primary SCG cell (PSCell). X interfaces are deployed between MN and SN1/SN2. At a time T1, UE may be operating in DC between MN and SN1. With the movement of the UE, at time T2, the SN for the UE may switch from SN1 to SN2. Such an SN Change can be initiated either by the MN or the source SN (e.g., SN1).

In some situations, such 5G network with high frequency and smaller cells, particularly for deployment in FR2 band, cell switch or SN change could be very frequent. To reduce interruption time and improve mobility reliability (i.e., mobility robustness), Conditional PSCell Addition/Change (CPA/CPC, or collectively CPAC) may be implemented. CPAC is defined as a PSCell addition/change that is executed by the UE when execution condition(s) is met. The UE starts evaluating the execution condition(s) upon receiving a CPAC configuration, and stops evaluating the execution condition(s) once the PSCell addition/change is triggered. The CPAC configuration, for example, may include candidate PSCell configuration (including SCG configuration generated by candidate SN(s) and possibly MCG configuration generated by the MN) and corresponding execution condition(s) for the candidate PSCell.

The CPAC procedure can be triggered by either the MN or the SN, so it can be categorized as MN initiated CPAC or SN initiated CPAC. In addition, the CPAC procedure can be involved with MN or without MN, so it can be classified as CPAC with MN involvement or CPAC without MN involvement (i.e., intra-SN CPC (Conditional PSCell Change) without MN involvement) as well.

For MN initiated CPA/CPC, the execution condition may be generated by the MN, e.g. Event A4, based on MCG MeasConfig. For SN initiated CPC, the execution condition may be generated by the source SN, e.g. Event A3/A5, based on SCG MeasConfig. Events A3, A4, and A5 may be defined as the following occurrence:
Event A3: Neighbor's measurement signal becomes better than PCell/PSCell by an amount of offset;
Event A4: Neighbor's measurement signal becomes better than an absolute threshold;
Event A5: PCell/PSCell becomes worse than one absolute threshold 1 AND Neighbor/SCell becomes better than another absolute threshold 2.

### MN Initiated and SN Initiated Selective Activation of Cell Group (CG)

For selective activation of CG change, the NW can pre-configure multiple candidate CG configurations and send the candidate CG configurations to the UE. The UE stores multiple candidate CG configurations. And the UE can perform CG change among candidate CGs based on the NW indication/signaling (e.g. RRC message, MAC CE) or the pre-configured execution conditions.

For simplicity, in the disclosure hereinafter, the term “candidate cell” may be alternatively referred to as “candidate cell group (CG).” The CG may be used to represent either one or both of MCG or SCG. The term candidate cell may be used to referred to candidate PCell in MCG, or candidate PSCell in SCG.

For MCG/PCell change, the term “selective activation of CG change” may be referred to as subsequent/successive Conditional Handover (CHO), or selective activation of MCG/PCell, MCG/PCell selective activation, conditional selective MCG/PCell, and the like. Likewise, for SCG/PSCell change, the term “selective activation of CG change” may be referred to as subsequent/successive Conditional PScell Change (subsequent/successive CPC), subsequent/successive Conditional PScell Addition (subsequent/successive CPA), subsequent/successive CPAC, selective activation of SCG/PSCell, SCG/PSCell selective activation, conditional selective SCG/PSCell, and the like.

In some of the implementations disclosed below, SCG/PSCell change (e.g., CPC) may be described as examples. The underlying principles and related solutions are applicable to MCG/PCell change as well unless otherwise explicitly described.

An example baseline procedure to support subsequent PSCell/SCG change is shown below:
The NW sends multiple candidate PSCell/SCG configurations and the execution conditions of candidate PSCell/SCG to the UE.
The UE stores multiple candidate PSCell/SCG configurations and evaluates the execution conditions of candidate PSCell/SCG. When the execution condition of a candidate PSCell/SCG is met, a UE performs an execution of CPA or CPC towards this candidate PSCell.
After finishing the PSCell addition or change, the UE may not release the conditional configuration of other candidate PSCells for subsequent CPC, and continues evaluating the execution conditions of other candidate PSCells.
When the execution condition of a candidate PSCell is met, the UE may then perform the execution of subsequent CPC towards this candidate PSCell.

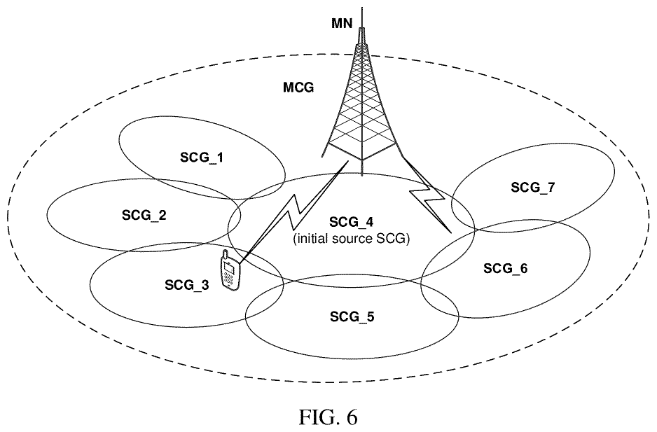

In order to support the subsequent CPAC, the candidate SCG/PSCell configurations need to be maintained after one SCG/PSCell addition or change (e.g. CPA/CPC or normal conditional PSCell addition/change). When UE moves to one specific candidate SCG/PSCell, some other candidate SCGs/PSCells may be not suitable as candidates for the next SCG/PSCell change (e.g. next CPC execution). For example, as shown in FIG. 6, there may be 7 candidate SCGs pre-configured by the NW for subsequent CPAC. When the UE moves to SCG_3, neighboring SCG_2, SCG_4, SCG_5 could be the candidate SCGs for the next SCG change. But other SCGs such as SCG_1, SCG_6, SCG_7 may not be suitable for the next CG change. Thus, the NW may further indicate for each candidate SCG, which candidate SCGs are available for the subsequent SCG change. The UE just needs to perform the evaluation on execution conditions for these available candidate SCGs when moving to a specific SCG, to avoid unnecessarily evaluating other candidates and also avoid frequent candidate updates via RRCReconfigurtaion (e.g., to release some candidates and re-add them again). In other words, the UE can maintain configuration of all the candidate SCGs/PSCells, but only need to monitor and evaluate a subset of SCGs/PSCells for the subsequent SCG/PSCell change. The subset of SCGs/PSCells are indicated by the NW.

The various example implementations are provided to describe example manners to prepare candidate SCG/PSCell configurations for SCG selective activation (e.g., subsequent CPAC) among various network elements, including indicating the available/subsequent candidate PSCells among all candidate PSCells to be evaluated when a candidate PSCell become a serving PSCell during the UE mobility.

### Example Procedure and Signaling for SCG Selective Activation/Subsequent CPAC

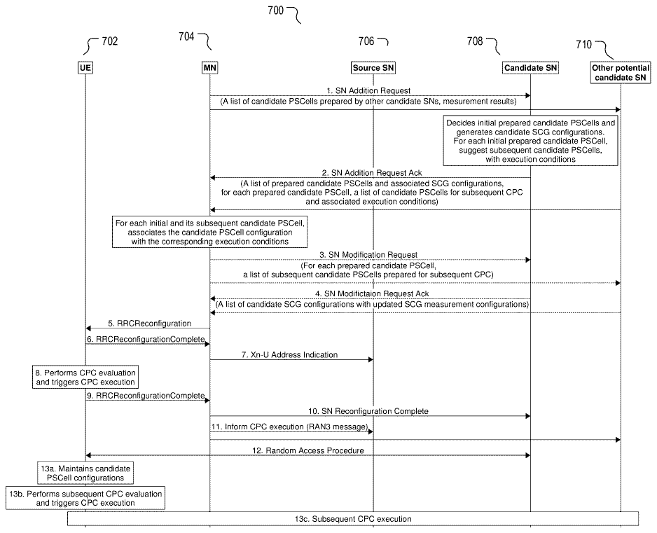

FIG. 7 shows an example data and logic flow 700 for SCG selective activation/subsequent CPAC. This procedure may be initiated by the MN for inter-SN subsequent CPAC. The example data and logic flow of FIG. 7 may include the following information exchange between the UE 702, the MN 704, the source SN 706, candidate SNs 708 and 710:

Step 1: The MN sends SN Addition Request message(s) to a set of candidate SNs, e.g., the candidate SN 708 and another candidate SN 710 (only one of these candidates is tracked below) to request a preparation/initiation of subsequent CPAC procedure. The message may include at least one of the following information (without so limited):
an upper limit for a number of PSCells (candidate PSCells) that can be prepared by the candidate SN;
measurements results related to the candidate SN(s);
a reference SCG configuration (so that the candidate SN only need to send differential/delta configuration of the various candidate SCG configurations);
an indication to indicate that the request is for selective activation or subsequent CPAC;
an indication to indicate/request the candidate SN to generate the reference SCG configuration.

Additionally or alternatively, if the MN is aware of the information about candidate PSCells that have been prepared by other candidate SN(s), the MN may also inform the candidate SN(s) of such candidate PSCells to, e.g., as candidate PSCells suggested for the subsequent CPC.

Step 2a: From the measurement results indicated by the MN or/and the list of PSCells suggested by the MN or/and the source SN, the candidate SN decides the list of PSCell(s) to prepare (i.e. initial prepared candidate PSCells), and provides the candidate PSCell/SCG configuration for each prepared candidate PSCell (e.g. based on the reference SCG configuration as, e.g., a differential/delta candidate PSCell configuration). If an indication that indicates that the request is for selective activation/subsequent CPAC or an indication indicating that the candidate SN/PSCell can suggest/select subsequent candidate PSCells for the next/subsequent CPC is received, for each initial prepared candidate PSCell, the candidate SN decides/suggests/selects subsequent candidate SNs or/and subsequent candidate PSCells for that prepared candidate PSCell. If a list of subsequent candidate SN IDs or/and subsequent candidate PSCells suggested for the next/subsequent CPC are provided by the MN, the candidate SN selects subsequent candidate SNs or/and PSCells from the list provided by the MN. The candidate SN may also provide execution conditions (e.g., events A3/A5 based execution conditions) for each subsequent candidate PSCells for the next/subsequent CPC. The execution condition may be based on the candidate SCG measurement configuration for the prepared candidate PSCell.

Step 2: The candidate SN sends an SN Addition Request Acknowledge message to the MN. The message may include the reference SCG configuration, and/or a list of prepared candidate PSCell IDs. It may also include at least one of the following information for each prepared candidate PSCell:
the candidate PSCell/SCG configuration;
a list of suggested subsequent candidate SNs or/and PSCells for the next/subsequent CPC, e.g., a list of subsequent candidate PSCell ID (e.g. CGI);
the execution conditions for each suggested subsequent candidate PSCells for the next/subsequent CPC, e.g., based on the candidate SCG measurement configuration.

Step 3: For each prepared candidate PSCell, if it has subsequent candidate PSCells, the MN can check whether there is a prepared candidate PSCell configuration for the subsequent candidate PSCell (whose configuration may be generated by other candidate SNs). If there is a prepared candidate PSCell configuration, the MN generates the association between the candidate PSCell configuration and the execution conditions for the subsequent candidate PSCell. If there is no prepared candidate PSCell configuration for the subsequent candidate PSCell, the MN may initiate SN addition procedure to a candidate SN that candidate PSCell belongs to, to request that SN to provide the candidate PSCell/SCG configuration for that PSCell. If there is a subsequent candidate PSCell whose candidate PSCell configuration or/and the execution condition are not prepared, the MN may inform the candidate SN. For example, for each prepared candidate PSCell or candidate SN, the MN may inform the candidate SN which subsequent candidate PSCells have been prepared (e.g., the cell whose candidate configuration and associated execution condition have been prepared) via an Xn/X2 message, e.g., an SN Modification Request message. The message may include a list of initial prepared candidate PSCells. For each initial prepared candidate PSCell, there may be a list of subsequent candidate SNs or/and candidate PSCells who have been prepared for the subsequent/next CPC.

Step 4: If requested (e.g., in response to the Xn/X2 message in Step 3 above), the candidate SN may send a response message to the MN via, e.g., an SN Modification Request message. In the response message, the candidate SN may include the execution conditions and/or the candidate SCG configurations with updated SCG measurement configurations, taking into account the prepared candidate PSCells for the subsequent CPC.

In some example implementations, Step 4 above and Step 5 below may also be performed between the MN and the source SN, e.g. when the source SN is considered as a candidate SN.

Step 5: The MN generates an RRC reconfiguration message, which includes the SCG selective activation/subsequent CPAC configuration. The SCG selective activation configuration/subsequent CPAC may include one or multiple reference configuration, and a list of prepared candidate PSCells. For each prepared candidate PSCell, it may include the candidate PSCell ID (e.g., the candidate PSCell configuration index, PCI+frequency), the candidate PSCell/SCG configuration, execution condition(s), a list of sk-counter or SN key or/and the information for the next/subsequent CPC. For the prepared candidate PSCell, the information for the next/subsequent CPC may include a list of subsequent candidate PSCells to be evaluated when the prepared candidate PSCell becomes a serving PSCell (i.e., after PSCell addition or change to the prepared candidate PSCell) or/and the execution condition(s) for each subsequent candidate PSCell. The MN sends the generated RRC reconfiguration message to the UE.

Step 6: The UE responds with an RRC reconfiguration complete message to the MN.

Step 7: The MN may inform the source SN that the SCG selective activation/subsequent CPAC procedure is configured/prepared, via an Xn/X2 message, e.g. an Xn-U Address indication message. If applicable, the source SN may start early data forwarding.

Step 8: The UE starts evaluating the execution conditions. If the execution condition(s) for one candidate PSCell is met, the UE performs CPAC procedure to the target PSCell. For example, the CPAC procedure may include applying the candidate cell configuration of that PSCell, and performing random access to that PSCell.

Step 9: The UE sends an RRCReconfigurationComplete message to the MN. The message may include information for enabling the MN to identify the SN of the selected candidate PSCell.

Step 10: The MN sends SN Reconfiguration Complete message to the target SN. If there is an SN key list, the target SN uses the first SN key in the list for the subsequent data transmission with the UE.

Step 11a/b: The MN sends an Xn/X2 message (e.g., an SN Release Request message, an Xn-U Address Indication message, or other message) to inform the source SN or/and candidate SN(s) about the CPC or CPA execution. The message may include an indication that the procedure is for SCG selective activation/subsequent CPAC. When receiving the message, the SN may stop providing user data to the UE, or/and to trigger late data forwarding procedure, if applicable. If the source SN is configured/considered as a candidate SN, the MN may indicate to the source SN that the UE context in SN is maintained, e.g., via an indication for SCG selective activation or an indication for UE context keep in the message. If the indication is included, the SN may keep the UE context. The source SN may discard/release/update the SN key which has been used. When receiving the message, the source SN or/and candidate SNs may update the SN key which could be used when the UE switches back to the same SN. The message to the source or candidate SN may indicate that SN to release or keep the candidate PSCells or a list of candidate PSCells prepared for the SCG selective activation. The source SN or/and candidate SNs may send a response message (e.g., an SN Release Request Acknowledge message) to the MN.

Step 12: The UE may synchronize to the selected target PSCell by, for example, performing random access.

Step 13a~c: The UE may maintain candidate PSCell configurations and performs evaluation of execution conditions on the maintained candidate PSCells or the candidate PSCells that are indicated to perform execution condition evaluation for the next CPC (if indicated by the NW). If the execution condition for one candidate PSCell is met, the UE performs subsequent CPC execution to the selected target PSCell.

In some example implementations, e.g. before Step 1, the MN may send a request message (e.g. SN addition or modification request message) to the source SN or the candidate SN to request that the SN provides the reference SCG configuration, e.g. include an indication for the reference configuration request. In response to receiving the message or the request indication, the source or candidate SN generates the reference SCG configuration and sends it to the MN, e.g. via SN addition or modification request message acknowledge message. The reference SCG configuration may be an RRC reconfiguration message generated by the SN.

In some example implementations, the MN may send the candidate PSCell configuration index for each initial prepared candidate PSCell to the candidate SN. The candidate SN may associate the candidate PSCell configuration index and the corresponding execution conditions for the subsequent candidate PSCell. In this case, a subsequent candidate PSCell list may be included in the candidate PSCell configuration for each initial prepared candidate PSCell.

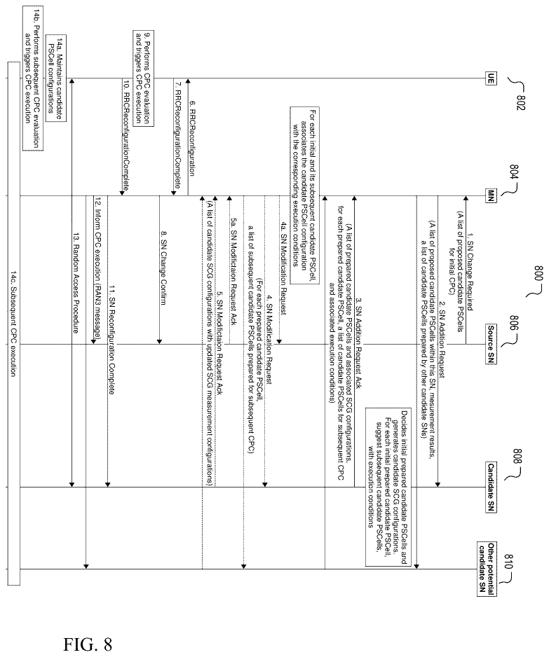

FIG. 8 shows another example data and logic flow 800 for SCG selective activation/subsequent CPAC. The procedure may be initiated by the source SN rather than the MN. The example data and logic flow of FIG. 8 may include the following information exchange between the UE 802, the MN 804, the source SN 806, candidate SNs 808 and 810:

Step 1: The source SN initiates the SCG selective activation/subsequent CPAC procedure by sending an SN change required message to the MN. The message may include at least one of the following information:
a list of candidate SN IDs suggested by the source SN;
the measurements results related to the candidate SN(s);
a list of proposed PSCell candidates recommended by the source SN;
the execution condition for each proposed PSCell candidate;
the upper limit for the number of PSCells that can be prepared by each candidate SN;
the reference SCG configuration generated by the source SN;
an indication to indicate that the request is for selective activation/subsequent CPAC;
an indication to indicate whether a candidate SN/PSCell can suggest the subsequent candidate PSCells for the next/subsequent CPC;
for each prepared candidate PSCell by a candidate SN, the upper limit for a number of PSCells that can be prepared for the next/subsequent CPC.

Step 2~7 of FIG. 8 are similar to Step 1~6 in FIG. 7.

Step 8: The MN may send a SN Change Confirm message to the source SN to indicate to the source SN that the SCG selective activation/subsequent CPAC procedure is configured/prepared.

Step 9~14c of FIG. 8 are similar to Step 8~13c in FIG. 7.

### Coexistence of Intra-SN and Inter-SN Subsequent CPAC

From a standpoint SN associated with a candidate cell for subsequent CPAC for a UE, the candidate cell may be intra-SN or inter-SN. For example, the disclosure above with respect to FIG. 7 and FIG. 8, inter-SN subsequent CPAC may be initiated either by the MN to an SN to identify inter-SN candidate cells and their configurations and execution conditions. Likewise, intra-SN CPAC may be implemented, where the candidate cell belongs to the source SN. The candidate cell, either inter-SN, or intra-SN, may be a candidate PSCell.

Correspondingly, in some implementations of subsequent CPAC, the network may potentially configure intra-SN CPC candidate cells and inter-SN CPC candidate cells simultaneously. Inter-SN CPC candidate cell configuration may be provided in MN format by the MN to the UE (e.g., in an MN RRC Reconfiguration message, as described in relation to Step 5 of FIG. 7 and Step 6 in FIG. 8), while intra-SN CPC candidate cell configuration may be provided in SN format by the SN to the UE (e.g., in an SN RRC Reconfiguration message). In some implementations, only one reference configuration may be provided to all prepared candidate PSCells and delta rather than full configuration information may be communicated between the network nodes. If only intra-SN subsequent CPAC is configured, the reference configuration can include SCG-only configuration, e.g., to reduce the signaling overhead and/or corrected recover the full configuration using the reference configuration and the transmitted delta configuration. However, if there is also an inter-SN subsequent CPAC configuration, the reference configuration would need to include both SCG and MCG configuration. Thus, the reference configuration used for intra-SN CPC candidate cell configuration and inter-SN CPC candidate cell configuration may be misaligned in configuration format when only one reference configuration is used and delta configuration rather than full configuration is signaled. For example, the source SN may first configure intra-SN candidates and reference configuration to the UE, the MN may not be aware of whether intra-SN candidates were configured or not when using delta configuration for inter-SN candidate. Thus, the MN may decide to configure MN initiated inter-SN candidates in that situation and request other candidate SN to provide delta configuration based on MN reference configuration format, which is different from the one being used for intra-SN candidates.

As such, the inter-SN case and intra-SN case may need be harmonized in terms of reference SCG configuration format, in order to, e.g., ensure that the same reference configuration is used for all candidate PSCells (inter-SN or intra-SN). One possible example solution is to configure intra-SN and inter-SN candidates by using a unified structure, e.g., both in MN format, so that a harmonized reference configuration can be used for all candidate PSCells.

In a case that the NW desires to prepare intra-SN CPC candidate cells for subsequent CPAC, at least one of the following alternatively may be considered to provide the subsequent CPAC configuration for the UE:
Alternative 1: The MN may decide to configure/initiate intra-SN subsequent CPC, and request the source SN to provide the candidate PSCell configuration(s) and/or execution condition(s), e.g., for generation of the final CPC configuration in MN format. For example, the following steps may be used:
   a. Step 1: The MN may send to the source SN an indication, via an Xn message, e.g., an SN Modification Request message, that the subsequent CPAC or intra-SN subsequent CPC is requested. The MN may also provide a maximum number of candidate PSCells (e.g., for subsequent CPAC) that can be prepared by the candidate SN, and/or an indication for requesting the reference SCG configuration.
   b. Step 2: The source SN may then decide on the candidate PSCells based on, e.g., the SCG measurement results. The source SN may then send a list of prepared candidate PSCells, and/or the reference SCG configuration to the MN via, e.g. an SN Modification Request Acknowledge message. For each candidate PSCell, the source SN may provide the candidate SCG configuration, the execution condition(s), and an indication of whether full/complete or delta configuration with respect to the reference SCG configuration is used. The source SN may also send the updated SCG measurement configurations (e.g., including measIDs to be used for the CPC execution condition) to the MN.
   c. Step 3: The MN may then generate the final candidate PSCell configuration, e.g., an MN RRC reconfiguration message containing an SN RRC reconfiguration message, which may include the candidate SCG configuration. The MN may then send the subsequent CPAC configuration to the UE via, for example, an RRCReconfiguration message. The message may include the candidate PSCell(s) configuration, the execution condition(s), and/or the reference configuration.
   d. Step 4: The UE may then respond with an RRC Reconfiguration Complete message to the MN. The message may include an SN RRC Reconfiguration Complete message.
   e. Step 5: The MN may inform the SN that the subsequent CPAC or intra-SN subsequent CPC is configured to the UE, via a Xn message (e.g. SN Reconfiguration Complete message).
Alternative 2: The source SN may decide/want to configure/initiate intra-SN subsequent CPC, and send the candidate PSCell configuration(s) and/or execution condition(s) to the MN, e.g., for generation of the final CPC configuration in the MN format. For example, the following steps may be used:
   a. Step 1: The source SN may decide on the candidate PSCells based on, e.g., the SCG measurement results. The source SN may then send an indication for subsequent CPAC or intra-SN subsequent CPC, a list of prepared candidate PSCells, and/or the reference SCG configuration to the MN via, e.g. an SN Modification Required or SN Change Required message. For each candidate PSCell, the source SN may provide the candidate SCG configuration, the execution condition(s), and indication of whether full/complete or delta configuration with respect to the reference SCG configuration is used. The source SN may also send the updated SCG measurement configurations (e.g. including measIDs to be used for the execution condition for CPC) to the MN.
   b. Step 2: The MN may then generate the final candidate PSCell configuration, e.g., an MN RRC reconfiguration message containing an SN RRC reconfiguration message, which may include the candidate SCG configuration. The MN may then send the subsequent CPAC configuration to the UE via, for example, an RRCReconfiguration message. The message may include the candidate PSCell(s) configuration, the execution condition(s), and/or the reference configuration.
   c. Step 3: The UE may respond with an RRCReconfigurationComplete message to the MN. The message may include an SN RRCReconfigurationComplete message.
   d. Step 4: The MN may respond to the source SN via, e.g., an SN Modification Confirm or SN Change Confirm message.
Alternative 3: The source SN may inform the MN that intra-SN subsequent CPC is to be configured or is requested to configure via an Xn message, e.g., an SN Modification Required message. The MN may response to the source SN via an Xn message, including at least one of the following information:
   an indication to indicate whether intra-SN subsequent CPC is allowed/accepted,
   an indication to indicate whether a reference configuration can be used for candidate cell configuration generation,
   an indication to indicate the source SN to generate the reference configuration, or
   the reference SCG configuration, e.g., used for candidate cell configuration generation.

According to the information received from the MN, the source SN may generate the subsequent CPC configuration, e.g. a list of prepared candidate PSCells, and/or the reference SCG configuration. The source SN may send the generated subsequent CPC configuration to the MN, e.g. via the steps/solutions in Alternative 2.

In some example implementations, the combination of the alternatives above may be implemented, e.g. combination of alternative 1+2, 1+3, 2+3, 1+2+3.

The indication/information mentioned above can be transferred by one of the following options:
Option 1: Including the indication/information directly in an Xn/X2 message, e.g., including the indication/information as one information element in an SN Addition/Modification Request (Acknowledge) message, or an SN Modification Required/Confirm message, etc.
Option 2: Including the indication/information in an RRC message, e.g., CG-ConfigInfo or CG-Config message. The RRC message may be included as one information element (or a container) in an Xn/X2 message, e.g., an SN Addition/Modification Request (Acknowledge) message, or an SN Modification Required/Confirm message, etc.

### L2 Handling for Subsequent CPAC

In subsequent CPAC described above, the role/type of intra-SN CPC and inter-SN CPC may change due to cell change/switching. For example, assuming that Cell 1, Cell 2 may both belong to the SN 1, and Cell 3 belongs to the SN 2. Also assume that the UE resides in Cell 1 prior to next cell switching. Cell 1 is thus the current serving cell for the UE, Cell 2 is an intra-SN CPC candidate (with respect to the current Cell 1), and Cell_3 is inter-SN CPC the candidate (with respect to the current Cell 1). However, after the UE performs a cell switch from Cell 1 to Cell 3, Cell 3 would become the current serving cell, whereas Cell 1 and Cell 2 would become inter-SN CPC candidate (rather than the current cell and intra-SN CPC cell prior to the switching, respectively).

Intra-SN cell change and inter-SN cell change may differ and thereby involving different requirements and procedures in several aspects. For example, SN key update may be required for inter-SN cell change, but may not be needed for intra-SN cell change. Thus, in the scenario above, switching from Cell 1 to Cell 2 (intra-SN change) may not require SN key update whereas switching from Cell 1 to Cell 3 (inter-SN change) would require SN key update. In addition, several L2 handling (e.g. PDCP re-establishment, PDCP data recovery, RLC re-establishment) may be different for intra-SN and inter-SN cell change. As a result, the UE may be required to know, upon triggering the execution of CPC, whether the cell switch/change is inter-SN or intra-SN cell.

The network (NW, e.g., MN or SN) can pre-configure several cell groups/sets for candidate cells and/or the serving/source cell to indicate, e.g., whether the source and target candidate cell belong to the same network node or cell group/set, whether key update (e.g., SN key update or MN key update) is required and/or which L2 handling procedures are performed upon triggering cell switch. Each cell group/set may include one or more candidate cells or the serving/source cell. For example, one or more cell group/set identifiers (IDs) or indexes may be configured for the cell groups/sets. Each candidate cell or serving/source cell belongs to one of the cell groups/sets. Thus, each candidate cell or the serving/source cell is associated with one of the cell group/set IDs or indexes for cell switching handling purposes. Such cell group/set IDs or indexes may be used to differentiate cell switch handling procedures that are inter-cell group/sets (e.g. inter-SN) and those that are intra-cell group/set (e.g. intra-SN). For example:
If a cell switch (e.g. CPC execution) is executed between cells belong to the same cell group/set (e.g., the cell group/set ID value of the source/serving cell is the same as the cell group/set ID value of the target candidate cell), the UE may perform at least one of the following operations upon triggering the cell switch: No security key (or SN Key) update/refresh, PDCP data recovery (for acknowledge mode data radio bearer (AM DRB)), RLC re-establishment or MAC reset;
If the cell switch (e.g. CPC execution) is executed between cells belong to different cell group/set (e.g. the cell group/set ID value of the source/serving cell is not the same as the cell group/set ID value of the target candidate cell), the UE may instead perform at least one of the following operations upon triggering the cell switch: security key (or SN key) update/refresh, PDCP re-establishment, RLC re-establishment or MAC reset.

In some example implementations, each SN may be associated with at least one cell group/set ID or index and different SNs may be associated with different cell group/set IDs or indexes. Serving or candidate cells of an SN may be associated with the same cell group/set ID or index.

In some example implementations, for SN key update, a list of counters (referred to as security key counters, or sk-counters) may be configured for each cell group/set. When the UE performs CPC execution between source and target cells belong to different cell group/sets (e.g. with the different cell group/set IDs or indexes), the UE may use an unused sk-counter among the list of counters associated with the cell group/set to which the target cell belongs for updating the security key (e.g., SN key).

An example of SN key update procedure is provided as follows:
The NW may pre-configure a list of SN counter (referred to as sk-counter) with values per candidate SN or candidate PSCell via RRCreconfiguration message with subsequent CPAC configuration (each candidate SN or candidate PSCell may belong to one of the cell groups/sets). The term “counter” or “counter value” may be used interchangeably below. In some example implementations, it may be up to the NW implementation to ensure that lists of sk-counter for candidate SNs or candidate PSCells do not overlap, e.g., different candidate SNs or candidate PSCells use different sets of sk-counters. For example, there may be several SN counter lists (e.g. sk-counter lists) with each list containing a set of sk-counters and each sk-counter is only associated with one of the sk-counter lists. Each list of sk-counters may be associated with each candidate SN or each cell group/set. Each SN counter list may include a series of sk-counters, or a sk-counter range (with respect to counter index, e.g. a start sk-counter index value+a sk-counter index value range).
The UE may store the received lists of sk-counters associated with the candidate SNs or candidate PSCells or cell groups/sets in its state variables.
The UE may then use an unused sk-counter to derive the SN key (e.g., K_{SN}) every time when the UE tries to access the same candidate SN or candidate PSCell as a target SN in cell switching (switching back from another candidate SN or candidate PSCell). The UE derives/updates the SN key based on a base station key of the candidate SN, e.g., K_{gNB}, and using the unused or first sk-counter in the stored list of sk-counters associated for the candidate SN or candidate PSCell. The UE may also remove the used sk-counter from the stored sk-counter list such that the remaining list of sk-counters of this candidate cell are unused. The UE may always use the first sk-counter in the stored list of remaining sk-counters when accessing this candidate SN or candidate PSCell. For example, upon triggering the CPAC execution, if the cell group/set ID or index associated with the target candidate cell is different from the cell group/set ID or index associate with the current serving/source cell, the UE uses the unused or first sk-counter in the sk-counter list associated with the cell group/set ID or index of the target candidate cell to derive/update the SN key. The UE may then remove the just used sk-counter from the sk-counter list of this cell group/set associated with the target candidate cell.
At CPAC execution, the UE may send an RRCReconfigurationComplete message to the MN. The message may include the selected candidate cell ID/index and/or the cell group/set ID or index associated with the selected candidate cell. Such information may enable the MN to identify the target candidate SN and/or the cell group/set of the selected candidate PSCell. Upon receiving the RRCReconfigurationComplete message, the MN generates the SN key for the selected target candidate SN by, e.g., deriving/updating the SN key based on the K_{gNB} above and using the unused or first sk-counter in the stored list for the target candidate SN. The MN may also remove the used sk-counter from the stored sk-counter list for the target candidate SN. The MN may then send the generated SN key to the target candidate SN, e.g. via SN Reconfiguration Complete message.
If there is no unused sk-counter associated with a candidate SN or candidate PSCell or cell group/set (e.g. the sk-counter list is empty after uses in previous switching to this SN), the UE may perform at least one of the following actions:
   a. Consider the candidate PSCell or candidate cells belonging to the candidate SN or the cell group/set is unavailable for the subsequent CPC;
   b. Remove/release the candidate cell configuration of the candidate PSCell or candidate cells belonging to the candidate SN or the cell group/set for subsequent CPC;
   c. Suspend/stop the execution condition evaluation of the candidate PSCell or candidate cells belonging to the candidate SN or the cell group/set. Then no cell switching or CPC to the corresponding cell can be triggered;
   d. Report to the NW that there is no usable sk-counter for the candidate PSCell or candidate cells belonging to the candidate SN or the cell group/set, or the candidate cell configuration of the candidate PSCell or candidate cells belonging to the candidate SN or the cell group/set is released, or the execution condition evaluation of the PSCell or candidate cells belonging to the candidate SN or the cell group/set is suspended/stopped, via, for example, RRC signaling (e.g. via UEAssistanceInformation message) or UL MAC CE.

### Subsequent CPAC Configuration

In some example implementations, the subsequent CPAC configuration may include at least one of the following:
One or multiple reference configurations. The reference configuration may be included in an RRCReconfigurtaion message. The reference configuration may include an MCG reference configuration and/or an SCG reference configuration;
A list of candidate cell set/group configurations, each including at least one of:
   a candidate cell set/group ID or index;
   a list of SN counter values or sk-counters.
A list of candidate PSCell configurations, each including at least one of:
   a candidate PSCell ID, e.g., a candidate configuration index, PCI+frequency;
   a candidate PSCell configuration;
   the execution conditions for the associated candidate PSCell;
   an indicator/flag to indicate the candidate cell is for subsequent CPAC;
   a reference configuration ID, to indicate the reference configuration used for the candidate PSCell;
   a candidate cell/group set ID, to refer to the cell group/set associated with the candidate PSCell; or
   a subsequent CPAC information configuration. This configuration may implicitly indicate that candidate PSCell is for subsequent CPAC (to differentiate from the legacy CPAC candidate PSCell). The subsequent CPAC information configuration may include a list of candidate PSCell information to be used when that candidate PSCell is/becomes the current serving PSCell. The information may include at least one of:
      a list of candidate cells to be released, e.g., when that candidate PSCell is/becomes the current serving PSCell;
      a list of candidate PSCells to be evaluated, which may include at least one of:
         a Candidate PSCell ID, e.g., candidate configuration index, PCI+frequency, to indicate the candidate PSCell to be evaluated, and/or the associated candidate PSCell configuration from the above candidate PSCell configuration list;
         the execution condition for the associated candidate PSCell.

In some example implementations, a subsequent CPAC information configuration may be included in the candidate PSCell configuration.

Example RRC signaling for CPAC and/or subsequent/successive CPC/CPA/CPAC configuration, the subsequent CPC/CPA/CPAC cell group/set configuration, the sk-counter list configuration therein, as described above, is illustrated below:

```
ConditionalReconfiguration
  -- ASN1START
  -- TAG-CONDITIONALRECONFIGURATION-START
  ConditionalReconfiguration-r16 ::= SEQUENCE {
        attemptCondReconfig-r16 ENUMERATED {true} OPTIONAL, -- Cond CHO
        condReconfigToRemoveList-r16 CondReconfigToRemoveList-r16
        OPTIONAL, -- Need N
        condReconfigToAddModList-r16 CondReconfigToAddModList-r16
        OPTIONAL, -- Need N
        condReconfigSetToAddModList-r18 CondReconfigSetToAddModList-r18
        OPTIONAL, -- Need N
        condReconfigSetToRemoveList-r18 CondReconfigSetToRemoveList-r18
        OPTIONAL, -- Need N
    ...
  }
    CondReconfigToRemoveList-r16 ::= SEQUENCE (SIZE (1.. maxNrofCondCells-r16)) OF
    CondReconfigId-r16
    CondReconfigSetToRemoveList-r18 ::= SEQUENCE (SIZE (1.. maxNrofCondSets-r18))
    OF CondReconfigSetId-r18
  -- TAG-CONDITIONALRECONFIGURATION-STOP
  -- ASN1STOP
CondReconfigSetToAddModList
    CondReconfigSetToAddModList-r18 ::= SEQUENCE (SIZE (1.. maxNrofCondSets-r18))
    OF CondReconfigSetToAddMod-r18
  CondReconfigSetToAddMod-r18 ::= SEQUENCE {
        condReconfigSetId-r18 CondReconfigSetId-r18,
        sk-CounterList-r18 SEQUENCE (SIZE (1..maxNrofSkCounters-r18)) OF SK-
        Counter OPTIONAL, -- Need M
    }
  CondReconfigSetId-r18 ::= INTEGER (1.. maxNrofCondSets-r18)
CondReconfigToAddModList
  -- ASN1START
  -- TAG-CONDRECONFIGTOADDMODLIST-START
    CondReconfigToAddModList-r16 ::= SEQUENCE (SIZE (1.. maxNrofCondCells-r16))
    OF CondReconfigToAddMod-r16
  CondReconfigToAddMod-r16 ::= SEQUENCE {
      condReconfigId-r16 CondReconfigId-r16,
      condExecutionCond-r16 SEQUENCE (SIZE (1..2)) OF MeasId
      OPTIONAL, -- Need M
      condRRCReconfig-r16 OCTET STRING (CONTAINING
      RRCReconfiguration) OPTIONAL, -- Cond condReconfigAdd
        ...,
      [[
      condExecutionCondSCG-r17 OCTET STRING (CONTAINING
      CondReconfigExecCondSCG-r17) OPTIONAL -- Need M
      ]],
      [[
      subsequentCondReconfig-r18 SubsequentCondReconfig-r18 OPTIONAL -
      - Need M
      cpc-CandidateSetId-r18 CPC-CandidateSetId-r18 OPTIONAL -- Need
      M
      ]]
    }
    CondReconfigExecCondSCG-r17 ::= SEQUENCE (SIZE (1..2)) OF MeasId
  SubsequentCondReconfig-r18 ::= SEQUENCE {
      candidateToEvaluationList-r18 SEQUENCE (SIZE (1.. maxNrofCondCells-
      r16)) OF CandidateToEvaluation-r18 OPTIONAL, -- Need M
      candidateToReleaseList-r18 SEQUENCE (SIZE (1.. maxNrofCondCells-r16))
      OF CondReconfigId-r16. OPTIONAL, -- Need M
      ...
    }
  CandidateToEvaluation-r18 ::= SEQUENCE {
      condReconfigId-r18 CondReconfigId-r16,
      condExecutionCondSCG-r18 OCTET STRING (CONTAINING
      CondReconfigExecCondSCG-r17) OPTIONAL -- Need M
  }
  -- TAG-CONDRECONFIGTOADDMODLIST-STOP
  -- ASN1STOP
```

### Handling of Candidate PSCell Configurations

In legacy CPAC, the candidate PSCell configurations should be released in some cases, e.g., upon SCG release, upon SCG deactivation, upon PCell/MCG change, upon entering into RRC_IDLE, upon entering into RRC_INACTIVTE, or upon transferring from RRC_INACTIVTE to RRC_CONNECTED (e.g., reception of RRCResume message). Thus, the NW needs to re-initiate CPAC procedure and re-configure candidate PSCell configuration if the NW decides to allow/use CPAC later, which may cause large signaling overhead.

For subsequent CPAC, the reference configuration can be stored separately for the candidate configurations, so the candidate configurations (e.g., delta configuration based on the reference configuration, or complete configuration) shall not be impacted in such cases, e.g., upon SCG release. It would be efficient and beneficial to reuse the stored candidate PSCell configurations for the subsequent CPAC, e.g., to avoid re-configure candidate PSCell configurations and to reduce signaling overhead.

For the cases mentioned as above, the NW can indicate whether to maintain/release/suspend candidate PSCell configurations or/and which candidate PSCell configurations can be maintained/released/suspended via, e.g., condReconfigToRemoveList in RRC message.

If candidate PSCell configurations are not released by the NW upon SCG release, the maintained candidate PSCell configurations can be used for the subsequent CPA. The UE may perform at least one of the following actions:
Option 1: evaluate the CPAC execution conditions for candidate PSCells. If the CPAC execution condition of one candidate PSCell is met, the UE may trigger CPA execution to the selected candidate PSCell.
Option 2: suspend/stop the evaluation of the CPAC execution conditions for candidate PSCells according to, e.g., the indication from the NW. The UE may resume/re-start the evaluation of the execution conditions for candidate PSCells (if it was suspended before) according to, e.g., the indication from the NW. For example, the NW may indicate to the UE the evaluation of execution conditions is allowed/started via, e.g., RRC message or MAC CE.

If candidate PSCell configurations are not released by the NW upon SCG deactivation, the UE may consider the SCG status of maintained candidate PSCells as deactivated during SCG deactivation. The UE may perform at least one of the following actions:
Option 1: continue the evaluation of the of the execution conditions for candidate PSCells according to, e.g., the indication from the NW. If the execution condition of one candidate PSCell is met, the UE may apply the corresponding candidate PSCell configuration, but may not perform the random access to the target candidate PSCell during SCG deactivation. The UE may perform the random access to the target candidate PSCell upon the NW activates/re-activates the SCG, e.g., receiving RRCReconfiguration message without scg-State IE.
Option 2: suspend/stop the evaluation of the execution conditions for candidate PSCells during SCG deactivation according to, e.g., the indication from the NW. The UE may resume/re-start the evaluation of the execution conditions for candidate PSCells (if it was suspended before) according to, e.g., the indication from the NW. For example, the NW may indicate to the UE that the evaluation is allowed/started or the NW activates/re-activates the SCG, e.g., receiving RRCReconfiguration message without scg-State IE.
   CHO with Candidate SCG(s)—Configuration of Execution Condition(s) for Candidate PSCell(s)

In some implementations, normal CHO configuration (even when including SCG configuration) may not consider the quality of candidate PSCell when triggering the CHO execution, and this may impact the UE throughput. To mitigate this throughput impact, CHO with candidate SCGs is considered.

In some situations, conditional handover (CHO) involving switching of PCell of MN together with candidate PSCell(s)/SCG(s) of SN(s), the network may provide candidate PCell configuration with candidate PSCell configuration(s) (e.g., each CHO configuration including MCG and SCG configurations), and execution conditions for the candidate PCells and the candidate PSCell(s). Upon receiving the candidate PCell and PSCell configurations, the UE may perform evaluation on candidate PCells and candidate PSCells simultaneously. When execution conditions for a candidate PCell and a candidate PSCell are met simultaneously, the UE may perform CHO with candidate SCG(s) procedure to access the target PCell and target PSCell.

In some example implementations, configuration of execution conditions for candidate PSCell(s) in CHO with candidate SCG(s) may be performed as follows:

Step 1: When the source MN decides to initiate the CHO with candidate SCG(s) procedure, if the source MN decides to let the source SN provide execution conditions for candidate PSCell(s), the source MN may trigger an SN modification procedure to the source SN to request the source SN to provide a list of proposed candidate SN(s)/PSCell(s) or/and associated execution condition(s). For example, the source MN may send an SN Modification Request message to the source SN with an indicator (e.g. CHO with candidate SCG(s) indicator, or CPAC indicator) to request the source SN to provide the proposed candidate SN(s)/PSCell(s) or/and associated execution condition(s).

Step 2: The source SN responses with a list of proposed candidate SN(s)/PSCell(s) or/and associated execution condition(s) to the source MN via, e.g., an SN Modification Request Acknowledge message.

Step 3: Upon receiving the response from the source SN, the source MN may send a Handover Request message (HO Request Message) to the candidate MN. The message may include the received list of proposed candidate SN(s)/PSCell(s).

Step 4: The candidate MN may select a candidate SN from the list of proposed candidate SN(s)/PSCell(s) and send an SN Addition Request message to that selected candidate SN with the proposed candidate PSCell(s).

Step 5: Within the list of PSCells proposed by the source SN, the candidate SN decides the candidate PSCell(s) to prepare with the candidate PCell. The candidate SN may then respond to the candidate MN with the prepared candidate PSCell(s) via, e.g., an SN Addition Request Acknowledge message.

Step 6: The candidate MN may send an HO Request Acknowledge message to the source MN, including the prepared candidate PSCell(s).

Step 7: If not all candidate PSCells suggested by the source SN were accepted by the candidate SN(s), the source MN may initiate an SN modification procedure to the source SN to update the execution conditions or/and source SCG measurement configuration (e.g. MeasConfig). The MN may indicate the candidate PSCells accepted by each candidate SN to the source SN via, for example, an SN Modification Request message.

Step 8: If requested, the source SN may send an SN Modification Request Acknowledge message and if needed, provide updated measurement configurations and/or the execution conditions to the source MN.

CHO with Candidate SCG(s)—Candidate Cell Configuration Preparation

In some implementations, a HO Request message may prepare only one candidate PCell. The corresponding HO Request ACK message may be constructed to include one candidate cell configuration (i.e. one RRCReconfiguration message) and may be sent to the source MN. However, in CHO with candidate SCG(s), the candidate MN may request multiple candidate PSCells for the same candidate PCell. In this case, it would be more efficient to include multiple candidate PSCell configurations with the same candidate PCell in one HO Request ACK message, e.g. to reduce the inter-node signaling interaction.

In some example implementations, different types of CHO may be established and defined for a candidate PCell. The source MN or the candidate MN can decide which type of CHO can be configured and whether different types of CHO can be configured simultaneously.

For example, the types of CHO may include at least one of the following:
CHO-only configuration (e.g., the candidate cell configuration only includes MCG configuration).
CHO with SN/SCG configuration (e.g., the candidate cell configuration includes both MCG and SN/SCG configurations, but without execution conditions associated with the candidate PSCell(s)).
CHO with configuration(s) of candidate SCG(s) (e.g., the candidate cell configuration includes both MCG and SCG configurations, and there are execution conditions associated with the candidate PSCell(s)).

In case that the type of CHO is decided by the source MN, when initiating a CHO with candidate SCG(s) procedure, the source MN may send an indicator to the candidate MN to indicate whether the complementary configuration is requested for the candidate PCell (e.g., to indicate whether the CHO-only and/or CHO with SN/SCG configuration is requested).

In case that the type of CHO is decided by the candidate MN, the candidate MN may decide whether to configure the complementary configuration for the candidate PCell. The candidate MN may take into account the maximum number of PCell that can be configured by the candidate MN as indicated by the source MN.

An example signaling procedure is illustrated below:

Step 1: The source MN may send an HO Request message to the candidate MN. The HO Request message may include the requested candidate PCell ID, an indicator to indicate that the request is for CHO with candidate SCG(s), a maximum number of candidate PSCells that the candidate MN is allowed to configure for the requested candidate PCell, a maximum number of conditional reconfiguration for CHO (e.g., including CHO with candidate SCG(s), CHO-only and/or CHO with SN) that the candidate MN is allowed to configure for the requested candidate PCell, a maximum number of conditional reconfiguration for CHO that the candidate MN is allowed to configure (e.g., for all prepared candidate cells belonging to the candidate MN), or/and an indication of whether complementary configurations (e.g., CHO-only configuration or CHO with SN/SCG configuration) is requested for the requested candidate PCell.

Step 2: The candidate MN may then decide candidate SN(s) for the requested candidate PCell, and send an SN addition request message to each candidate SN to request each candidate SN to prepare candidate PSCell(s), including the maximum number of candidate PSCells that can be prepared in each candidate SN, which may be the same as or less than the maximum number of candidate PSCells or conditional reconfiguration for CHO indicated by the source MN.

Step 3: The candidate SN may then reply with an SN addition request acknowledge message to the candidate MN. The message may include cell ID(s) of the prepared candidate PSCell(s), and corresponding candidate SCG configuration(s).

Step 4: The candidate MN may then generate a set of candidate configurations for PCells and PSCell(s) via, e.g. multiple RRCReconfiguration messages, each including one MCG configuration (for the same candidate PCell) and one SCG configuration (for the different candidate PSCells). If a complementary configuration (e.g. CHO-only configuration or CHO with SN/SCG configuration) is requested by the source MN, or the candidate MN decides to provide complementary configuration for the candidate PCell, the candidate MN may generate the complementary configuration for the candidate PCell. The candidate MN may also generate execution condition parameters for the prepared candidate PSCell(s) (e.g., event A4 threshold described above). The candidate MN may then send an HO Request Acknowledge message to the source MN. The HO Request Acknowledge message may include one or more candidate cell configurations. Each candidate cell configuration may include or be associates with at least one of the following information:
Candidate cell configuration ID;
The candidate PCell ID, e.g. PCI+frequency or CGI;
The candidate PSCell ID, e.g. PCI+frequency, CGI;
Candidate cell configuration (e.g. via RRCReconfiguration message);
The execution condition parameter(s), e.g., the measurement object specific offset of the reference signal of the neighbor/candidate cell (e.g. offsetMO), the cell specific offset of the neighbor/candidate cell (e.g. cellIndividualOffset), hysteresis parameter, event threshold parameter, timer to trigger (i.e. TTT) parameter, and the like;
An indication of whether to request the source SN to generate the execution conditions of candidate PSCell(s).

The indication/information mentioned above can be transferred by one of the following options:
Option 1: Including the indication/information directly in an Xn/X2 message, e.g., including the indication/information as one information element in an SN Addition/Modification Request (Acknowledge) message, or a Handover Request (Acknowledge) message, etc.
Option 2: Including the indication/information in an RRC message, e.g., CG-ConfigInfo or CG-Config message. The RRC message is included as one information element (or a container) in an Xn/X2 message, e.g., an SN Addition/Modification Request (Acknowledge) message, or a Handover Request (Acknowledge) message, etc.

An example signaling for candidate cell configuration list is illustrated below:

```
Handover-CandidateList message
  -- ASN1START
  -- TAG-HANDOVER-COMMAND-LIST-START
  Handover-CandidateList ::= SEQUENCE {
      criticalExtensions CHOICE {
        c1 CHOICE{
            handover-CandidateList-r18 Handover-CandidateList-r18-IEs,
          spare3 NULL, spare2 NULL, spare1 NULL
        },
        criticalExtensionsFuture SEQUENCE { }
      }
    }
  Handover-CandidateList-r18-IEs ::= SEQUENCE {
      handover-CandidateToAddModList-r18 SEQUENCE (SIZE (1..maxNrofCondCells-
      r16)) OF Handover-CandidateInfo-r18 OPTIONAL,
      handover-CandidateToReleaseList-r18 SEQUENCE (SIZE (1..maxNrofCondCells-
      r16)) OF Handover-CandidateInfoId-r18 OPTIONAL,
      nonCriticalExtension SEQUENCE { } OPTIONAL
    }
  Handover-CandidateInfo-r18 ::= SEQUENCE {
      handover-CandidateInfoId-r18 Handover-CandidateInfoId-r18,
      condPSCellId-r18 CondPSCellId-r18 OPTIONAL,
      handoverCommandMessage-r18 OCTET STRING (CONTAINING
      RRCReconfiguration),
      condExecutionCondPSCell-r18 CondExecutionCondPSCell-r18 OPTIONAL
    }
  CondPSCellId-r18 ::= SEQUENCE {
      ssbFrequency-r18 ARFCN-ValueNR,
      physCellId-r18 PhysCellId
    }
  CondExecutionCondPSCell-r18 ::= SEQUENCE {
    a4-Threshold-r17 MeasTriggerQuantity,
    hysteresis-r17 Hysteresis OPTIONAL,
    timeToTrigger-r17 TimeToTrigger OPTIONAL,
    offsetMO Q-OffsetRangeList OPTIONAL,
    cellIndividualOffset Q-OffsetRangeList OPTIONAL,
    ...
  }
  -- TAG-HANDOVER-COMMAND-LIST-STOP
  -- ASN1STOP
```

In some example implementations, for one candidate cell configuration (e.g. Handover-CandidateInfo above), if there is no associated candidate PSCell ID and/or no execution conditions of the candidate PSCell, it means that the candidate cell configuration is a complementary configuration for the candidate PCell.

### Layer-1/Layer-2 (L1/L2) Triggered Mobility (LTM)

In traditional implementation, serving cell change may be triggered by layer-3 (L3) measurements and initiated via RRC signaling triggered Reconfiguration with synchronization for change of PCell and/or PSCell, as well as via RRC signaled release or add of SCells when applicable. Such PCell and/or PSCell change, add, or release involve complete layer-2 (L2) and layer-1 (L1) resets, leading to longer latency, larger overhead and longer interruption time than intra-cell beam switch mobility.

In some example implementations, L1/L2 triggered mobility (LTM) may be used to enable a serving cell change via L1/L2 signaling, rather than involving L3, in order to reduce the latency, overhead and interruption time. For example, an LTM procedure may involve a base station receiving L1 measurement report(s) from a UE, and the base station changing UE's serving cell based on the received L1 measurement report(s) by a cell switch command signaled via a MAC CE. The cell switch command may indicate an LTM candidate cell configuration that the base station previously prepared and provided to the UE through, for example, RRC signaling. Then the UE may switch to the target cell according to the cell switch command.

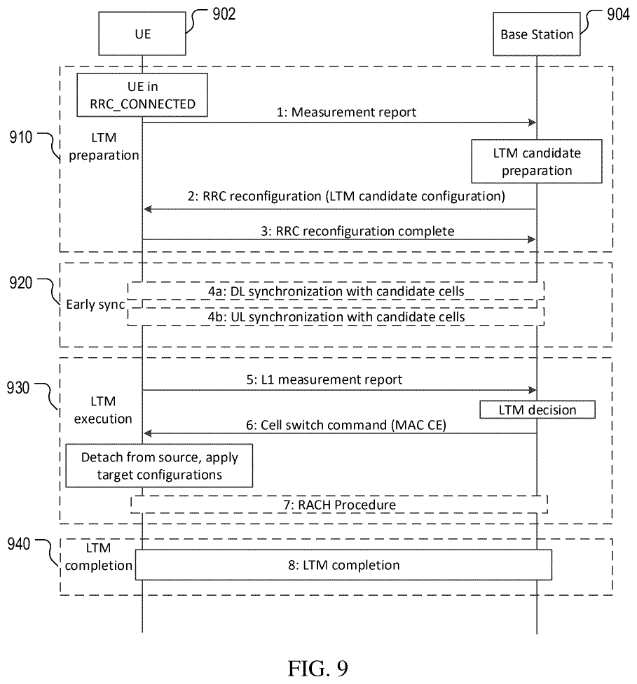

LTM may be particularly applied to subsequent cell switching. An example overall procedure for LTM is shown in FIG. 9. The implementation of FIG. 9 includes and LTM preparation procedure 910, and Subsequent LTM, for example, may be formed by the UE 902 and base station 904 by repeating the procedures of early synchronization 920, LTM execution 930, and LTM completion 940 without releasing other LTM candidate cell configurations after each LTM completion, including the following example steps:

1. The UE 902 sends a MeasurementReport message to the base station 904. The base station decides to configure LTM and initiates preparation of candidate cell(s).

2. The base station 904 (e.g. the source cell) transmits an RRCReconfiguration message to the UE 902 including the LTM configuration of one or multiple candidate cells. The LTM configuration may include LTM candidate cell configuration, L1 measurement configuration, TCI-state configuration, and/or early uplink (UL) synchronization configuration, etc.

3. The UE 902 stores the LTM candidate cell configurations and transmits an RRCReconfigurationComplete message to the base station 904.

4a. The UE 902 performs downlink (DL) synchronization with candidate cell(s) before receiving the cell switch command.

4b. The UE 902 may perform acquisition of early Time Advance (TA) for uplink communication with candidate cell(s) requested by the network before receiving the cell switch command. This may be done via Contention-Free Random Access (CFRA) triggered by a PDCCH order from the source cell. Thereafter, the UE 902 may send preamble(s) towards the indicated candidate cell. In order to minimize data interruption of the source cell due to CFRA towards the candidate cell(s), the UE 902 may not receive Random Access Response (RAR) for the purpose of TA value acquisition and the TA value of the candidate cell may be indicated in the cell switch command. The UE 902 may not maintain the TA timer for the candidate cell and may rely on network implementation to guarantee the TA validity.

5. The UE 902 performs L1 measurements on the configured candidate cell(s), and transmits lower-layer measurement reports to the base station 904. L1 measurement may be performed as soon as applying the RRC reconfiguration in step 2 above.

6. The base station 904 decides to execute cell switch to a target cell, and transmits a MAC CE triggering cell switch by including the candidate configuration index of the target cell. The UE 902 switches to the target cell and applies the configuration indicated by candidate configuration index.

7. The UE 902 performs random access (RA) procedure towards the target cell, if UE 902 does not have valid TA of the target cell.

8. The UE 902 completes the LTM cell switch procedure by sending RRCReconfigurationComplete message to the target cell. If the UE 902 has performed a RA procedure in step 7, the UE considers that LTM execution is successfully completed when the random-access procedure is successfully completed. For RACH-less LTM, the UE 902 considers that LTM execution is successfully completed when the UE determines that the network has successfully received its first uplink (UL) data.

Steps 4-8 above can be performed multiple times for subsequent LTM cell switch using the LTM candidate cell configuration(s) provided in step 2.

In some implementations, the source cell may decide to activate one or more TCI-states associated with candidate cell(s), e.g. via a MAC CE, before triggering the LTM execution (e.g. sending LTM cell switch command to the UE). The decision may be performed according to the L1 measurement results of candidate cells reported from the UE. And then the source cell may decide to trigger LTM execution to switch to one of the candidate cells, and send the LTM cell switch command to indicate the selected target candidate cell. Upon reception of the LTM cell switch command, the UE may execute the LTM to access the target candidate cell and send an RRCReconfigurationComplete message to the target candidate cell. The RRCReconfigurationComplete message may include the activated TCI-state(s) associated with the target candidate cell (which was activated by the source cell before LTM cell switch), in order to allow the target candidate cell to use the activated TCI-state(s) to communicate with the UE and reduce the latency caused by TCI-state activation upon/after cell switch.

### LTM-L1 Measurement Configuration

In LTM, the L1 measurement Reference Signal (RS) configuration may include at least one of the following information: Physical Cell ID (PCI) or logical cell ID (e.g., candidate cell configuration index), time domain configuration (e.g. Synchronization signal/PBCH block Measurement Timing Configuration (SMTC) or periodicity and Synchronization Signal/PBCH Block (SSB) position in burst), frequency domain location (e.g., center frequency), Subcarrier Spacing (SCS), SSB power (e.g., ss-PBCH-BlockPower), or Channel State Information Reference Signal (CSI-RS) configuration.

In some implementations, the L3 measurement object configuration has included the similar configuration for SSB and/or CSI-RS based L1 measurement RS configuration. In order to reduce the signaling overhead, the L3 SSB and/or CSI-RS measurement configuration can be considered to be also used for L1 measurement. For example, an SSB reference configuration (referring to MeasObjectId) can be introduced in the L1 measurement RS configuration to refer to the SSB specific configuration in the corresponding MeasObject (e.g. ssbFrequency, ssbSubcarrierSpacing, smtc, or SSB-ConfigMobility). A CSI-RS reference configuration (referring to MeasObjectId) can be introduced in the L1 measurement RS configuration to refer to the CSI-RS specific configuration in the corresponding MeasObject (e.g., csi-rs-ResourceConfigMobility). The UE may use the SSB and/or CSI-RS specific configuration in the referred L3 measurement object configuration to perform the L1 measurement for candidate cell(s).

An example signaling for LTM RS configuration is illustrated below:

```
LTM-CSI-SSB-ResourceConfig ::= SEQUENCE {
    ssbFrequency ARFCN-ValueNR OPTIONAL, -- Need M
    ssbSubcarrierSpacing SubcarrierSpacing OPTIONAL, -- Need M
    periodicity-r17 ENUMERATED { ms5, ms10, ms20, ms40, ms80, ms160, spare2,
    spare1 } OPTIONAL, -- Need M
    ssb-PositionsInBurst-r17 CHOICE {
      shortBitmap BIT STRING (SIZE (4)),
      mediumBitmap BIT STRING (SIZE (8)),
      longBitmap BIT STRING (SIZE (64))
    } OPTIONAL, -- Need M
    ss-PBCH-BlockPower-r17 INTEGER (−60..50)
    ssbReference MeasObjectId OPTIONAL, -- Need M
    ...
  }
```

### LTM—TCL-State Configuration

A set of Transmission Configuration Indicator (TCI) states for candidate cell(s) may be provided by the NW (e.g., TCI states may be included in LTM-Config). Such TCI-states can be used for early DL synchronization, and/or beam/spatial relation indication for the DL/UL transmission.

For each TCI-state configuration, it may include or be associated with at least one of the following information: the candidate cell ID (e.g., the candidate cell configuration ID/index), the Bandwidth Part (BWP) ID, the BWP location (e.g., start frequency location of the BWP), or the BWP bandwidth.

### LTM—LTM in NR-DC

For NR-DC case, the following cases may need to be considered:
Case 1: SCG LTM without MN involvement, e.g., the SCG LTM execution does not impact the current MCG configuration;
Case 2: MCG LTM without SN involvement, e.g., the MCG LTM execution does not impact the current SCG configuration;
Case 3: SCG LTM with MN involvement, e.g., the SCG LTM execution impacts the current MCG configuration;
Case 4: MCG LTM with SN involvement, e.g., the MCG LTM execution impacts the current SCG configuration.

In some example implementations, if MCG LTM execution impacts the current SCG configuration (e.g., case 4 as above), the MCG LTM may need to trigger MR-DC release (to release the SCG) upon MCG LTM execution. Some solution may be considered in handling the SCG upon MCG LTM execution with the following example alternatives:
Alternative 1: The NW (e.g., target cell) may configure/indicate the SCG release in the candidate cell configuration, e.g., the MCG LTM candidate cell configuration may include mrdc-SecondaryCellGroupConfig that is set to release. The UE shall release the SCG based on the indication in the candidate cell configuration when performing the MCG LTM execution.
Alternative 2: The UE may autonomously release SCG upon execution of LTM on MCG, e.g., the UE may release the radio resource configuration on MCG and SCG of the source cell when replacing the source configuration with the target candidate configuration.
Alternative 3: The NW may pre-configure one or more cell sets/groups of candidate cells within the MCG, e.g., the cell switch among the candidate cells within the same cell set/group may have no impact on the SCG, which may not trigger the SCG release upon execution of LTM on MCG. The cell switch across the cell sets/groups may trigger the SCG release upon the execution of LTM on MCG. For example, each candidate cell may be configured with a cell group/set ID:
   a. If the source cell and target candidate cell are associated with the same cell group/set ID, the UE may not release the SCG upon MCG LTM execution.
   b. If the source cell and target candidate cell are associated with different cell group/set IDs, the UE may release the SCG upon MCG LTM execution.

In some example implementations, if the SCG is released due to the trigger of MCG LTM execution (e.g., released by the UE autonomously or released by the NW via the candidate cell configuration as above), the MN may need to inform the SN to release the UE context and relevant resources at the SN. There are two example options that may be considered:
Option 1: The MN (e.g., MN CU) may initiate the SN release procedure towards the SN (e.g., SN CU) to release the UE context and relevant resources at the SN when the MCG LTM is triggered. The (source) MN DU may inform the MN CU that the MCG LTM is triggered via an F1 message, e.g., when/after the (source) MN DU sends the LTM cell switch command to the UE (to trigger the LTM execution). The F1 message may include the target candidate cell ID/index.
Option 2: The MN (e.g., MN CU) may initiate the SN release procedure towards the SN (e.g., SN CU) to release the UE context and relevant resources at the SN when the MCG LTM is executed successfully, e.g., when the (target) MN DU informs the MN CU that the UE has accessed that target candidate cell the via an F1 message (e.g., Access Success message), or when the target candidate cell receives the first UL transmission (e.g., RRCReconfigurationComplete) from the UE.

In some example implementations, if the MN DU decides to trigger the LTM execution, the MN DU may inform the MN CU that LTM is to be triggered via, e.g., an F1 message. The F1 message may include a selected target candidate cell ID/index. And then the MN CU may initiate an SN release procedure towards the SN (e.g., SN CU) to release the UE context and relevant resources at the SN, e.g., according to whether the selected target candidate cell belongs to a cell group/set or not. When the SN is released, e.g., the SN release acknowledgement from the SN is received at the MN CU, the MN CU may inform the MN DU via an F1 message. And then the MN DU may send the LTM cell switch command to trigger the LTM execution.

### LTM—LTM Upon MCG/SCG Failure

In some example implementations of LTM, failure recovery procedures may be performed upon MCG/SCG LTM failures.

For example, upon an MCG failure, a fast MCG recovery procedure may be performed to recovery the MCG link via, e.g., MCG LTM. In particular, the MN may decide to trigger LTM cell switch on MCG to recovery the MCG link, after receiving the MCG failure report from the UE via, e.g., an MCGFailureInformation message. In this case, a procedure for sending the MCG LTM MAC CE to the UE via SCG may be considered with the following example alternatives:
Alternative 1: The MN may generate an MCG LTM MAC CE and sends the MAC CE to the SN. The SN may include the MN generated MAC CE in an SN generated MAC CE (e.g., an SCG MAC CE including an embedded MCG MAC CE), and send the SN generated MAC CE to the UE. An example procedure may include:
   a. Upon reception of the MCG Failure Information message, if the MN CU decides to use LTM for MCG link recovery, the MN CU may send an F1 message to the MN DU to request the DU to generate the MCG LTM MAC CE. The target candidate cell may be decided by the CU or the DU. If the target candidate cell is determined by the CU, the CU may inform the DU of the selected target candidate cell via an F1 message.
   b. The MN DU may determine the target candidate cell and/or other information required for LTM cell switch (e.g. the TA value of the target candidate cell, the TCI-state/beam information of the target candidate cell) and generate the MCG LTM MAC CE. The MN DU may then send the MAC CE to the MN CU.
   c. The MN CU may transfer the received MCG LTM MAC CE to the SN CU via an Xn message.
   d. The SN CU may generate an SCG MAC CE containing the received MCG LTM MAC CE, and send the SCG MAC CE to the UE.
   e. The UE may then trigger LTM execution to the target candidate cell as indicated in the MCG LTM MAC CE contained in the SCG MAC CE.
Alternative 2: The MN may decide to trigger LTM cell switch to an MCG LTM candidate cell. The MN may transmit the information required for LTM, e.g., target candidate cell configuration ID, TA, TCI-state/beam information, etc., to the SN. The SN may then generate the LTM MAC CE including the information required for MCG LTM, and send the SCG MAC CE (e.g. LTM MAC CE) to the UE. The SCG MAC CE may include an indication that the LTM is triggered for MCG. An example procedure may include:
   a. Upon reception of the MCG Failure Information message, if the MN CU decides to use LTM for MCG link recovery, the MN CU may send an F1 message to the MN DU to request the DU to send the information required for LTM to the MN CU. The target candidate cell may be determined by the CU or the DU. If the target candidate cell is decided by the CU, the CU may inform the DU of the selected target candidate cell via an F1 message.
   b. The MN DU may decide the target candidate cell and/or other information required for LTM cell switch (e.g., the TA value of the target candidate cell, the TCI-state/beam information of the target candidate cell) and send such information to the MN CU.
   c. The MN CU may transfer the received information for MCG LTM to the SN CU via an Xn message.
   d. The SN CU may generate an SCG MAC CE including the received information for MCG LTM, and an indication that the LTM cell switch is for MCG.
   e. The UE may then trigger MCG LTM execution to the target candidate cell, based on the information as indicated in the received SCG MAC CE.

For another example, upon an SCG failure, a fast SCG recovery procedure may be performed to recovery the SCG link, e.g. via SCG LTM. In particular. the SN may trigger SCG LTM cell switch after receiving the MCG failure report from the UE via, e.g., an SCGFailureInformation message. In this case, similar alternative as indicated above for MCG recovery situation may be adopted to send an SCG LTM MAC CE to the UE via MCG.
Alternative 1: The SN may generate an SCG LTM MAC CE and send the MAC CE to the MN. The MN may include the SN generated MAC CE in an MN generated MAC CE (e.g., an MCG MAC CE including an embedded SCG MAC CE), and send the MN generated MAC CE to the UE to trigger the execution of SCG LTM.
Alternative 2: The SN may decide to trigger LTM cell switch to an SCG LTM candidate cell. The SN may transmit the information required for LTM, e.g., target candidate cell configuration ID, TA, TCI-state/beam information, etc., to the MN. The MN may then generate the MCG MAC CE (e.g., LTM MAC CE) including the information required for SCG LTM, and send the MCG MAC CE to the UE. The MCG MAC CE may include an indication that the LTM is triggered for SCG.

For another example, upon detecting an MCG failure during SCG LTM cell switch, the UE may initiate a connection re-establishment procedure.

For yet another example, upon detecting an SCG failure during MCG LTM cell switch, the UE may initiate the SCG failure information procedure after completion of MCG LTM execution.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a master node (MN) for a wireless terminal, comprising:
receiving a candidate cell preparation message from a secondary node (SN) of the wireless terminal, the candidate cell preparation message comprising a cell identifier for a candidate PSCell, a candidate secondary cell group (SCG) configuration of the candidate PSCell, or an execution condition associated with the candidate PSCell for the subsequent CPC procedure;
generating a reconfiguration message for the subsequent CPC based on the candidate cell preparation message, the reconfiguration message comprising a candidate cell configuration of the candidate PSCell and the execution condition; and
sending the reconfiguration message to the wireless terminal.

2. The method of claim 1, wherein the candidate cell preparation message further comprises at least one of:
a reference SCG configuration; or
an indication to indicate whether the candidate SCG configuration is a full/complete or delta configuration with respect to the reference SCG configuration.

3. The method of claim 1, wherein the candidate cell configuration comprises the candidate SCG configuration.

4. The method of claim 3, wherein the candidate cell configuration is contained in an MN radio resource control (RRC) reconfiguration message.

5. The method of claim 1, further comprising sending a request message to the SN to request a preparation for the subsequent CPC procedure, wherein the candidate cell preparation message is sent by the SN in response to the request message.

6. The method of claim 5, wherein the request message comprises at least one of:
an indication that the request message is for requesting preparation for intra-SN subsequent CPC, or
an indication to request a reference SCG configuration.

7. The method of claim 5, wherein:
the request message is an SN modification request message; and
the candidate cell preparation message is an SN modification request acknowledge message.

8. The method of claim 1, wherein the candidate cell preparation message is initiated by the SN in preparation of the subsequent CPC procedure, and wherein the candidate cell preparation message is an SN modification required message.

9. A method performed by a wireless terminal in a wireless network, comprising:
receiving candidate cell configurations and execution conditions for one or more candidate cells, and a cell group identifier associated with each of the one or more candidate cells;
triggering a cell switch from a source cell of the wireless terminal to a target candidate cell among the one or more candidate cells when the execution condition associate with the target candidate cell is met; and
determining whether the cell group identifier associated with the source cell is the same as the cell group identifier associated with the target candidate cell.

10. The method of claim 9, wherein the cell group identifier indicates a cell group that a corresponding candidate cell belongs to, and wherein the cell group is configured with a security key counter list.

11. The method of claim 10, wherein the method further comprises, in response to the cell group identifier associated with the source cell being the same as the cell group identifier associated with the target candidate cell, performing a first procedure comprising at least one of:
adopting a security key previously generated at the wireless terminal and associated with the source cell for communication with the target candidate cell;
performing Packet Data Convergence Protocol (PDCP) data recovery for acknowledge mode data radio bearer (AM DRB); or
switching to the target candidate cell.

12. The method of claim 11, wherein the method further comprises, in response to the cell group identifier associated with the source cell being different from the cell group identifier associated with the target candidate cell, performing a second procedure, wherein the second procedure comprises at least one of:
determining a cell group to which the target candidate cell belongs among a set of cell groups;
regenerating the security key for communication with the target candidate cell based on a value of a selected security key counter among the security key counter list associated with the cell group;
performing a PDCP re-establishment;
switching to the target candidate cell; or
removing the selected security key counter from the security key counter list.

13. The method of claim 12, wherein the security key counter list comprises an ordered list of security key counters and the selected security key counter is a top-most or an unused security key counter in the ordered list of security counters.

14. The method of claim 12, further comprising:
determining whether a security key counter list associated with the cell group is empty;
in response to that the security key counter list is empty, performing at least one of:
considering the target candidate cell as unavailable for a subsequent CPC;
considering the target candidate cell belonging to the cell group as unavailable for the subsequent CPC;
removing the candidate cell configuration of the target candidate cell or candidate cells belonging to the cell group for the subsequent CPC;
suspending execution condition evaluation of the target candidate cell or candidate cells belonging to the cell group for the subsequent CPC; or
reporting to the wireless network at least one of:
no usable security counter for the target candidate cell or the cell group is available;
the candidate cell configuration of the target candidate cell or candidate cells belonging to the cell group is released; or
the execution condition evaluation of the target candidate cell or candidate cells belonging to the cell group is suspended or stopped.

15. The method of claim 14, wherein reporting to the wireless network is via RRC signaling or uplink MAC CE.

16. A method performed by a source MN for a wireless terminal, comprising
transmitting a handover (HO) request message to a candidate MN, the HO request message indicating a type of conditional handover (CHO);
receiving an HO request acknowledgement message from the candidate MN, the HO request acknowledgement message being generated by the candidate MN according to the type of CHO as indicate in the HO request message.

17. The method of claim 16, wherein the type of CHO comprises at least one of:
a first type indicating a conditional handover involving master cell group switching only;
a second type indicating a conditional handover involving master cell group and secondary cell group switching without execution conditions associated with the secondary cell group switching; or
a third type indicating a conditional handover involving master cell group and secondary cell group switching with execution conditions associated with the secondary cell group switching.

18. The method of claim 17, wherein the type of CHO indicated in the HO request message is the third type and the HO request message further comprises at least one of:
an identifier for a candidate PCell;
a maximum number of candidate PSCells that the candidate MN is allowed to configure for the candidate PCell;
a maximum number of conditional reconfiguration for all types of CHO that the candidate MN is allowed to configure for the candidate PCell;
a maximum number of conditional reconfiguration that the candidate MN is allowed to configure for all types of CHO; or
an indication to indicate whether the second or third type of CHO is requested to prepare for the candidate PCell.

19. The method of claim 17, wherein the type of CHO indicated in the HO request message is the third type and the HO request acknowledgement message comprises at least one of:
an identifier for a candidate PCell;
an identifier for a candidate PSCell associated with the candidate PCell;
a candidate cell configuration for the candidate PCell and the associated candidate PSCell; or execution condition parameters associated with the candidate PSCell.

20. The method of claim 19, wherein the execution condition parameters comprise at least one of:
a measurement object specific offset of a reference signal of the candidate PSCell;
a cell specific offset of the candidate PSCell;
a hysteresis parameter;
an event threshold parameter; or
a time-to-trigger parameter.

21-25. (canceled)
